(19) United States
(12) Patent Application Publication
(10) Pub. No.: US 2009/0151515 A1
(43) Pub. Date: Jun. 18, 2009

(54) Double male metric hex torque & removal adapter, for removing, reinstalling and torquing tubular motor cycle axles, foreign and domestic

(76) Inventor: George P. Veltri, Poquoson, VA (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(21) Appl. No.: 11/404,489

(22) Filed: Dec. 14, 2007

(51) Int. Cl. B25B 15/00

(52) U.S. Cl. 81/52

(57) ABSTRACT

A motorcycle axle tool including two male hex key ends on opposite ends of the tool is described. The motorcycle axle tool may include an axial hole and a radial hole. The tool may be made of any hard material capable of withstanding the torque required to remove a typical axle nut, such as a stainless steel, other tool steel, or aluminum, preferably the tool is made from a hardened stainless steel such as 17-4 precipitation hardening stainless steel.

### FIELD OF THE INVENTION

Embodiments of the invention are directed to a motorcycle axle installation and removal tool. Specific embodiments are directed to a motorcycle axle repair tool comprising a two male metric hex adapter for removing, reinstalling and torquing tubular motor cycle axles. Embodiments of the tool may be used with an impact driver.

### BACKGROUND

Tubular motor cycle axles are typically a two part assembly. The axles comprise a hollow shaft which has a metric hex socket head on one end and a male thread on the other and an axle nut which has a metric hex socket head on one end and internal threads on the other that match and screw into the tubular axle. Removal of modern axles may be difficult due to the amount of torque required to remove the axle nut and advanced lightweight materials used to produce the shaft and axle nut.

There is a need for a tool that makes removal of axles easier without damage to the axle or the tool used to remove the axle. Additionally, there is a need for a tool that can easily be removed from the axle after use and a tool that is convenient for emergency road repairs.

### SUMMARY OF THE INVENTION

Embodiments of the invention are directed to a tool comprising only two male hex key ends on opposite ends of the tool. The hex ends may be male hex key ends for removing axle nuts with female hex socket drive. The female hex socket drive on the motorcycle axle nut is usually a 19 mm, 22 mm or 24 mm. In one embodiment, the motorcycle axle tool of the present invention comprises a 22 mm male hex key end and a 24 mm male hex key end. Additional embodiments of the motorcycle axle tool may comprise a 15 mm male hex key end and one of a 19, 20, or 22 male hex key end.

In another embodiment, the motorcycle tool comprises a ½″ socket drive on one end and one of a 19 mm, 22 mm, and 24 mm male hex key on the other end. The motorcycle tool of this embodiment, or any other embodiment, may have a radial and/or an axial hole.

The tool may be made of any hard material capable of withstanding the torque required to remove a typical axle nut, such as a stainless steel, other tool steel, or aluminum, preferably the tool is made from a hardened stainless steel such as 17-4 precipitation hardening stainless steel.

The motorcycle axle tool will be described in more detail below and in relationship to various drawings and embodiments.

### BRIEF DESCRIPTION OF THE FIGURES

FIGS. 1A, 1B, and 1C show an embodiment of the motorcycle axle tool of the invention comprising a 22 mm male hex key end, a 15 mm male hex key end, a radial hole with a diameter of 0.261″, and an axial hole with a diameter of .341″ to allow the tool to be more easily removed if it get stuck in the female drive;

FIGS. 2A and 2B show a perspective view of the motorcycle axle tool of FIG. 1;; the length of each end is ¾″ to allow sufficient material to be inserted into the female drive;

FIGS. 3A and 3B show an embodiment of the motorcycle axle tool of the invention comprising a 22 mm male hex key end, a ½″ square socket drive; and an axial hole to allow the tool to be more easily removed if it get stuck in the female drive; and

FIGS. 4A and 4B show a perspective view of the motorcycle axle tool of FIGS. 3A and 3B.

### DESCRIPTION OF THE INVENTION

The invention is directed to a motorcycle axle tool for removing or installing a motorcycle axle. In certain embodiments, the invention provides a double male, metric hex torque & removal adapter. Tubular motor cycle axles are typically a two part assembly. The axles comprise a hollow shaft which has a metric hex socket head on one end and a male thread on the other and an axle nut which has a metric hex socket head on one end and internal threads on the other that match and screw into the tubular axle. The tool may be specifically manufactured to separate these two parts, enabling the tubular axle to be removed, serviced, reinstalled and torqued to manufacturer's specifications. The tool is particularly useful in breakdown situations, because the axle can be removed using only the tool, and it is small enough to fit in the tool kit compartment of a motorcycle.

Embodiments of the invention are directed to a tool comprising only two male hex key ends on opposite ends of the tool and the other described optional features. Either hex end may be a male hex key ends for removing axle nuts with female hex socket drive. One side may be inserted into the female hex socket and the other side may be turned by use of a box wrench, socket wrench, crescent wrench, or other appropriate tool. Optionally, the motorcycle axle tool may comprise a radial hole for insertion of a rod to apply a torque and turn the tool to remove or install the axle.

The female hex socket drive on a motorcycle axle nut is usually a 19 mm, 22 mm or 24 mm. In one embodiment, the motorcycle axle tool of the present invention comprises a 22 mm male hex key end and a 24 mm male hex key end. Additional embodiments of the motorcycle axle tool may comprise a 15 mm or 16 mm male hex key end on one end and one of a 19, 20, or 22 male hex key end on the other end. Preferably, the motorcycle axle tool will comprise two closely sized male metric hex key ends.

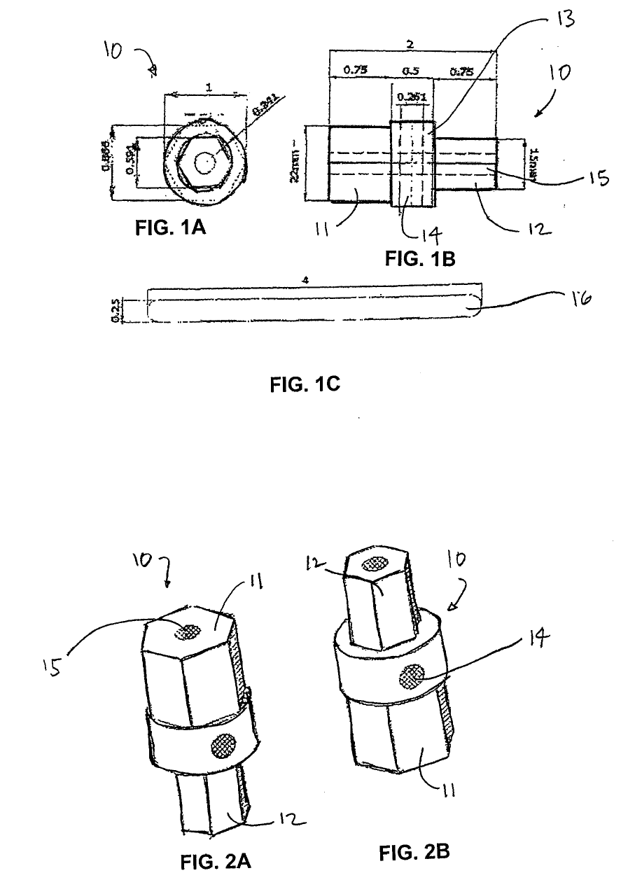

A motorcycle axle tool of the invention may consist of a first male hex key, a second male hex key, and a center portion, wherein the center portion defines a radial aperture and the first male key portion, the center portion, the second male portion define an axial aperture. The center portion may connect the first male hex key and the second male hex key. For example, FIGS. 1A, 1B, and 1C show an embodiment of the motorcycle axle tool 10 of the invention comprising a 22 mm male hex key end 11, a 15 mm male hex key end 12, a center portion 13, a radial hole 14 with a diameter of 0.261″, and an axial hole 15 with a diameter of .341″. The handle 17 may be inserted into radial hole 14 to allow torque to be applied to the tool to remove or install the axle nut on a motorcycle axle. Axial hole 15 allows the tool 10 to be removed from the axle nut should the tool become jammed in the female socket of the axle nut. A rod, such as handle 16, may be inserted in axial hole 15 or compressed air may be blown into axial hole 15 to assist in freeing the tool 10. It is preferable if the axial hole of embodiments of the present invention is less than 10 mm at its smallest diameter to allow efficient use of compressed air to assist in removal of the tool, otherwise it may be more difficult to build up sufficient pressure behind the tool to assist in its removal from the female socket.

FIGS. 2A and 2B show a perspective view of the motorcycle axle tool 10 of FIGS. 1A and 2A. It is important to note that nothing is on the end of either of the male hex keys that would result in the tool bottoming out in the female socket of the axle nut. If the motorcycle axle tool bottoms out in the female socket of the axle nut, the required male hex key may not have sufficient engagement of the female socket and the tool may be difficult and/or unsafe to use or damage to the tool or motorcycle axle will likely occur. The motorcycle axle tools of the invention do not include any features, such as additional hex keys or other protrusions, on the end of the tool that would interfere with the engagement of the tool with the female socket. Both ends 11 and 12 of motorcycle tool 10 are ¾″ in length to allow sufficient material to be inserted into the female drive. On tools with additional, more than two, hex drives either the outer hex drive bottoms out in the female socket when the inner drive is required or the outer drive is too short to provide proper engagement, or bite, to the tool and damage and unsafe conditions may occur. Overall the motorcycle axle tool 10 is only 2″ in length which is convenient for storing the tool on the motorcycle and therefore be available for emergency repairs. Preferably, embodiments of the motorcycle repair tool are less than 3″ in total length.

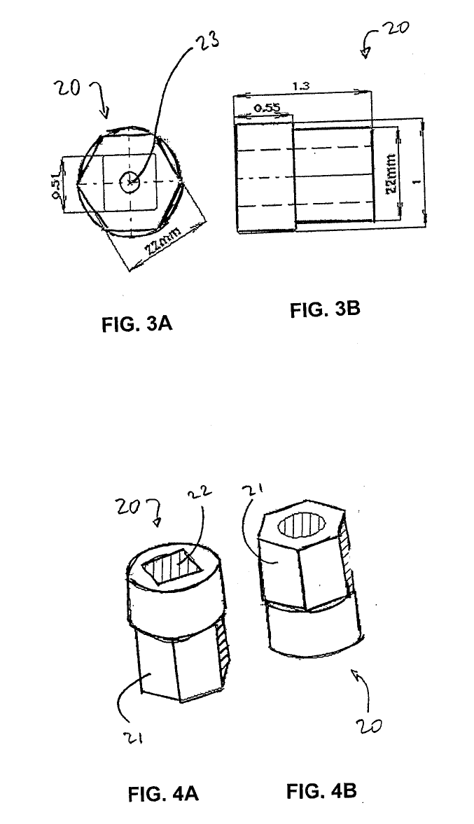

In another embodiment, the motorcycle tool comprises a ½″ socket drive on one end and one of a 19 mm, 22 mm, and 24 mm male hex key on the other end. Of course, the tool could comprise other sized socket ends, either English or metric sizes. FIGS. 3A and 3B show an embodiment of the motorcycle axle tool 20 comprising a 22 mm male hex key end 21, a ½″ square socket drive 22; and an axial hole 23 to allow the tool to be more easily removed if it get stuck in the female drive. A ½″ drive is required to allow the tool to withstand enough torque to remove an axle nut that may have been overtightened or has seized on the axle. FIGS. 4A and 4B show a perspective view of the motorcycle axle tool 20 of FIGS. 3A and 3B.

The tool may be made of any hard material capable of withstanding the torque required to remove a typical axle nut, such as a stainless steel, other tool steel, or aluminum, preferably the tool is made from a hardened stainless steel such as 17-4 precipitation hardening stainless steel.

There is not one standard size for the female socket of motorcycle axles, therefore the motorcycle axle tools may be provided and manufactured with any desired male hex socket head size. Embodiments of the tool comprise only two male hex key ends on opposite ends of the tool. The female hex socket drive on a typical motorcycle axle nut is usually a 19 mm, 22 mm or 24 mm. In one embodiment, the motorcycle axle tool of the present invention comprises a 22 mm male hex key end and a 24 mm male hex key end. Additional embodiments of the motorcycle axle tool may comprise a 15 mm or 16 mm male hex key end and one of a 19, 20, or 22 male hex key end. The 15 mm or 16 mm hex end can be used with a standard metric wrench and the other end will fit the motorcycle axle. In still another embodiment, the motorcycle axle tool will comprise two male hex key ends in consecutive standard metric or English sizes. Standard metric sizes include 4, 6, 7, 8, 10, 12, 14, 15, 16, 17, 19, 20, 22, 24 through 30 mm as well as other sizes, such as tools including a 15 mm and 16 mm hex ends or 17 mm and 19 mm hex ends, 20 mm and 22 hex ends, or 22 mm and 24 mm hex ends. The radial hole allows the insertion of a rod or bar to turn the tool to remove or install the axle. The use of the rod or bar is particularly useful in an emergency roadside repair or other situation when one does not have access to a complete set of tools.

### EXAMPLE 1

The first end of the tool consists of a male 15 mm hex drive (or 16 mm hex drive for European models), with a hole drilled laterally to accept a ¼″ hardened shaft. This allows the tool to be used as a T-handle, so it alone will remove the axle. It can also be used in association with a 15 MM socket, box-end wrench, open-end wrench or adjustable wrench.

The second end consists of a male metric hex key available in a plurality of sizes that fits into the female metric hex socket drive on the screw end of the tubular axle. A ¼″ hole extends all the way through the tool longitudinally to provide a means of removing the socket from the axle should it become stuck due to residue in the axle.

Manufacture

The motorcycle axle tool may be manufactured from 17-4 precipitation hardening stainless steel. The tool may be first turned and drilled on a lathe, then the hexes are milled on both ends and a hole is drilled and reamed through the center perpendicular to the hexes to fit a ¼″ rod. After manufacture the unit is heat-treated for durability.

Function

In order to remove, service, install and torque an axle, the following steps are taken: 1. The female socket of the axle is measured to determine the proper adapter size to be used. 2. If use as a T-handle is desired, the hardened shaft is inserted laterally through the tool. If use with a wrench is desired, a 15 mm socket, box-end, open-end or adjustable wrench is applied to the 15 mm male hex drive. 3. The cinch bolts are loosened from the head of the tubular axle. They are left tight on the nut end of the axle. 4. The male hex end of the adapter with appropriate wrench attached is inserted into the female hex drive of the tubular axle. 5. The adapter/wrench assembly is turned counter clockwise to loosen the tubular axle from the axle nut. 6. The cinch bolts on the nut end of the axle are loosened, permitting removal of the tubular axle nut. 7. The desired service is performed on the axle. 8. The axle is reinserted through both forks, encapsulating the wheel, axle, and associated parts. 9. The tool is again inserted into the female hex drive of the tubular axle and turned clockwise to firmly tighten the axle into the axle nut. 10. The cinch bolts are retightened. 11. This is an example temporary roadside repair wherein a torque wrench is not available. At this point the motorcycle should be driven to the nearest facility where it can be torqued to manufacturer's specifications.

Though the invention has been described in relation to various embodiments and Figures, it will be apparent to those skilled in the art that many modifications, additions, and deletions can be made therein without departing from the spirit and scope of the invention and its equivalents as set forth in the following claims.

1-8. (canceled)

9. A motorcycle axle tool, consisting essentially of:
a first male hex key end of a first size;
a second male hex key end of a second size on the opposite side of the tool as the first hex end, wherein the first size is different than the second size;
a center portion defining a radial through hole; and
the first hex end, the second hex end and the center portion defining an axial through hole, wherein the tool is made from a hardened steel.

10. (canceled)

11. The tool of claim 10, wherein the axial through hole is less than 10 mm across at its narrowest point.

12. The tool of claim 11, wherein the radial hole is less than 10 mm across at its narrowest point.

13. The tool of claim 12, wherein the hardened steel is a 17-4 precipitation hardening stainless steel.

14. The tool of claim 13, wherein the male first hex key end is a 15 mm male hex key end and the second male hex key end is a 16 mm hex end.

15. The tool of claim 13, the male first hex key end is a 17 mm male hex key end and the second male hex key end is a 19 mm hex end.

16. The tool of claim 13, the male first hex key end is a 22 mm male hex key end and the second male hex key end is a 24 mm hex end.
